(19) United States
(12) Patent Application Publication
(10) Pub. No.: US 2015/0344338 A1
(43) Pub. Date: Dec. 3, 2015

(54) CONTAINED AND FULLY CONTAINED PHYTO-CELL FOR WASTEWATER DISPOSAL

(71) Applicant: Brad Alan Granley, Parker, CO (US)

(72) Inventor: Brad Alan Granley, Parker, CO (US)

(21) Appl. No.: 14/724,762

(22) Filed: May 28, 2015

Related U.S. Application Data
(60) Provisional application No. 62/004,801, filed on May 29, 2014.

(51) Int. Cl. C02F 3/32

(52) U.S. Cl. CPC C02F 3/32; C02F 2103/001

(57) ABSTRACT

An apparatus and method for phytoremediation (phyto-utilization) in a contained cell or fully contained cell to reduce the volume of wastewater and/or to remediate contaminated soil and/or wastewater from various sources, while protecting surrounding soil and groundwater resources is disclosed. This invention provides a means and apparatus to use phytoremediation at any location by containing the phytoremediation process at its base with an impermeable barrier, and if desired, fully enclosing the process aboveground within a structure. A fully enclosed process allows for year round plant growth, increased transpiration during colder seasons, and exclusion of precipitation from the system which in turn increases the net evapotranspiration of wastewater by the plant-based system.

### CROSS-REFERENCE TO RELATED APPLICATIONS

This application claims priority to provisional application 62/004,801, the disclosure of which is incorporated by reference as if fully set forth herein.

### TECHNICAL FIELD

The embodiments described herein relate to a plant-based phyto-utilization system for consuming wastewater including, but not limited to, leachate from landfills.

### BACKGROUND

The problem of handling wastewater generated from various processes and systems is a major societal issue. Because wastewater frequently contains harmful chemicals, it cannot be disposed of in a manner that would pose a risk to human health or the environment. One specific concern is avoidance of groundwater contamination. That is, wastewater that comes in contact with groundwater can cause severe environmental damage by, for example, contaminating otherwise potable water.

In general, the disposal of wastewater has historically involved either: (1) transporting wastewater to a site dedicated to treatment of contaminated or hazardous materials; and/or (2) treatment via a flow-through “filtering” technique (i.e., physical, chemical, or biological treatment) either on-site where the wastewater is generated or via transportation to a site where the wastewater can be treated. Both options involve significant costs and some level of contamination is typically released to the environment.

A particularly promising method of treating wastewater is phytoremediation. In phytoremediation, plants are used to remove contaminants from wastewater, or to enhance the biological degradation of contaminants through increased population of microorganisms that break down contaminants.

Various types of filtering systems using phytoremediation are known in the art. Published Application WO 01/27033 discloses a method and apparatus for treating fluids via a biological filter. In the system disclosed therein, wastewater is sent into a filtering system via an inlet. The filter bed contains soil with plants planted throughout. Treated water exits the system (i.e., is discharged) via an outlet for further use.

U.S. Pat. No. 7,407,577 to Kerns discloses a tertiary filter septic system and a method of using the system to purify sewage. Kerns discloses a plenum containing a fluid collection portion and a fluid filter portion. Sewage is sent to the fluid collection portion of the plenum. Once there, material in the fluid collection portion wicks the wastewater so that it is contacted with aquatic plants planted in the wicking material. Kerns specifically discloses the use of peat as the wicking material. After the wastewater passes through the wicking material, it is released (i.e., is discharged) into a dispersal mound.

Both of the foregoing systems involve use of a growth media such as soil or peat wherein plants are planted. However, hydroponic filtering systems are also taught in the literature. For example, A. R. Navarro et al., Clean Techn Environ Policy (2012) 14:41-45 describe a hydroponic filtering system to treat lemon industry wastewater to produce biogas. Similarly, Khandare et el Biotechnol Lett (2014) 36:47-55 teaches a hydroponic phyto-tunnel filtering system for treating dye-containing waste water.

Conventional landfills sometimes contain phytoremediation systems that consume leachate from the landfill. U.S. Pat. Nos. 5,947,041 and 6,250,237 describe a method for using poplar trees as a vehicle for controlling pollution. However, these systems are different than the embodiments described herein. One of the differences is that the systems lack an impermeable barrier that is proximate to the growing medium for the vegetation in the system. In a conventional landfill, there may exist a landfill liner that is buried far beneath the surface through depths of refuse that may approach 250 feet. In contrast to the embodiments described herein, these systems cannot be moved outside of a landfill without additional risks of harmful chemicals contaminating the surrounding soil and groundwater.

### BRIEF DESCRIPTION OF THE DRAWINGS

FIG. 1 shows a side cut-away view of a wastewater disposal system in accordance with an aspect of an illustrative embodiment.

FIG. 2 shows a top view of a wastewater disposal system in accordance with an aspect of an illustrative embodiment.

### SUMMARY

It has been surprisingly found that use of a phyto-cell to consume wastewater at or near the source of its generation results in tremendous cost savings over approaches that involve hauling wastewater (usually via truck) to treatment facilities. Also, significant environmental and ancillary benefits are realized by a site owner and the public including, but not limited to, the following (1) reduced carbon footprint (diesel not burned by tanker trucks hauling leachate and significant carbon sequestration by the plants): (2) reduced truck traffic through communities; (3) reduced liability for the site owner and improved safety for the public with tanker trucks off the roads; (4) less wear and tear of roads; (5) reduced loading on wastewater treatment plants; and (6) reduced discharge of wastewater that often still contains contaminants to surface water bodies. The embodiments described herein are directed to a “contained phyto-cell”. That is, a phyto-cell as described herein and shown in the attached drawings that has been constructed using an impermeable barrier at its base. In addition, a further embodiment described herein is directed to a “fully-contained phyto-cell” that is a contained phyto-cell that additionally includes an enclosure (e.g., a greenhouse or other structure) to create a controlled environment. The enclosure reduces the amount of precipitation that can enter the system and can extend the growing season.

In one aspect, the embodiments shown relate to a contained phyto-cell which comprises an impermeable barrier defining a perimeter and base of the phyto-cell; a liquid influent connected to the phyto-cell for distributing influent into the phyto-cell; a growth media located in the area defined by the impermeable barrier; and vegetation in the growth media for consuming the influent.

It should be noted that when it is stated that the vegetation “consumes” the influent, it means that the system is distinct from “flow through” systems where wastewater is treated or filtered and subsequently discharged as described in the above-prior art. The liquid is consumed (eliminated from the system) through a combination of evaporation (e.g., from sunlight, heat and wind) and transpiration by the plants. Some influent will be stored in the growth media as residual moisture.

It should further be noted that conventional landfills may contain an impermeable barrier far below the landfill surface and underneath waste disposed in the landfill to prevent leachate seeping out of the landfill and contaminating groundwater. These barriers or liners may be placed at a depth that can approach up to 250 feet below the landfill surface. This type of structure is different than the embodiments described herein in several ways. In the embodiments described herein, the soil or other plant-growth media in the phyto-cell is proximate to the base of the impermeable barrier by being in contact with it and/or being separated by additional ingredients that facilitate flow, distribution, and operation of the phyto-cell. For example, crushed rocks, sand, or gravel material can be used to create flow channels to allow for distribution of wastewater across the phyto-cell. In a preferred embodiment, the impermeable barrier of the embodiments described herein is placed at 1 to 10 feet beneath the surface of the growth media. In a highly preferred embodiment, the impermeable barrier is placed between 2-5 feet beneath the surface of the growth media.

In another aspect, the embodiments comprise an enclosure above the phyto-cell so that it is fully contained.

In still another aspect, the embodiments described are located either on a landfill or outside a landfill. When the phyto-cells described herein are located on a landfill environment, the system does not need to rely on the leachate collection system of the landfill to prevent contamination from reaching clean soil and groundwater.

In still another aspect, the vegetation in the phyto-cell is a hybrid poplar tree, willow tree, vetiver grass, or some other tree or plant to accomplish the same purpose. Mixtures of various types of vegetation may be used.

In still another aspect, the phyto-cell contains a liquid influent to permit distribution of wastewater to the phyto-cell. The liquid influent can take a variety of shapes depending on the needs of the phyto-cell. The liquid influent may be a single pipe, a manifold, a distribution network (i.e., multiple pipes). Multiple types of liquid influents may be used in combination. Note that the liquid influent may feed into the phyto-cell at various locations. For example, at soil level, below soil level, or above the soil (e.g., using an open or perforated pipe, spray or sprinkler type system or drip irrigation). In a preferred embodiment, the liquid influent is positioned such that it discharges fluid into the cell (e.g., over an edge of the impermeable barrier). That is, it does not have to be physically touching the phyto-cell (e.g., it could be positioned over the phyto-cell). However, the influent could be connected to the phyto-cell through the impermeable barrier by, for example, a hole in the barrier. If this arrangement is used, the hole would be sealed around the influent by conventional means to prevent discharge of wastewater and to maintain the impenetrability of the barrier.

In still another aspect, the phyto-cell contains a level control for controlling the amount of influent in the cell. The level control can also be used to re-circulate the influent within the cell.

In still another aspect, the phyto-cell contains an infiltration reduction runner that can prevent rainwater from entering the phyto-cell.

The phyto cell may be constructed of a single-cell or it may be constructed as a collection of cells. When a collection of cells is used, the phyto-cells may take a variety of arrangements. For example, the cells may be interconnected (either in series or in parallel) or the cells may be stand-alone.

The phyto-cell may further comprise an aerator attached to the phyto-cell. The aerator may be connected to the phyto-cell by piping placed across the bottom of the cell and pumping air into the phyto-cell. Nevertheless, various pipe locations can be used to effect aeration of the cell and additional evaporation of wastewater.

Another aspect of the embodiments described herein involves a method of consuming wastewater by use of either a contained phyto-cell or fully contained phyto-cell as described herein. In a general aspect, the method comprises delivering wastewater influent to the phyto-cell bed via a liquid influent, and contacting the influent with the vegetation to consume the influent.

### DETAILED DESCRIPTION OF ILLUSTRATIVE EMBODIMENTS

As required, detailed illustrative embodiments are disclosed herein; however, it is to be understood that the disclosed embodiments are merely exemplary of the invention that may embodied in various and alternative forms. The figures are not to scale and some details may be exaggerated or minimized to show details of particular components. Therefore, the specific structural and functional details described herein are not to be interpreted as limiting, but merely as a representative basis for teaching one skilled in the art to variously employ the illustrative embodiments disclosed herein.

It has been surprisingly found that there is a great advantage of a phyto approach as outlined herein in that the plants consume, or utilize, the liquid so it does not need to be hauled away, sometimes over great distances or through communities, to a wastewater treatment plant for disposal. This technology significantly reduces the costs to manage (dispose of) leachate or other wastewater (due to not paying haulers or a wastewater treatment plant). The approach can also replace other, more costly pre-treatment methods. Costs are easily cut by 25-50%, and often times more, up to as much as 90% over the long term. The approach also results in significant green benefits and other ancillary benefits such as a reduced carbon footprint for the facility and landfill owner (no diesel burned to haul leachate and further sequestration of carbon from the atmosphere by the plants can amount to 100 tons or more per year per project), reduced liability for the generator due to taking leachate hauling trucks off the road, less truck traffic through communities, less wear and tear on roads, etc.

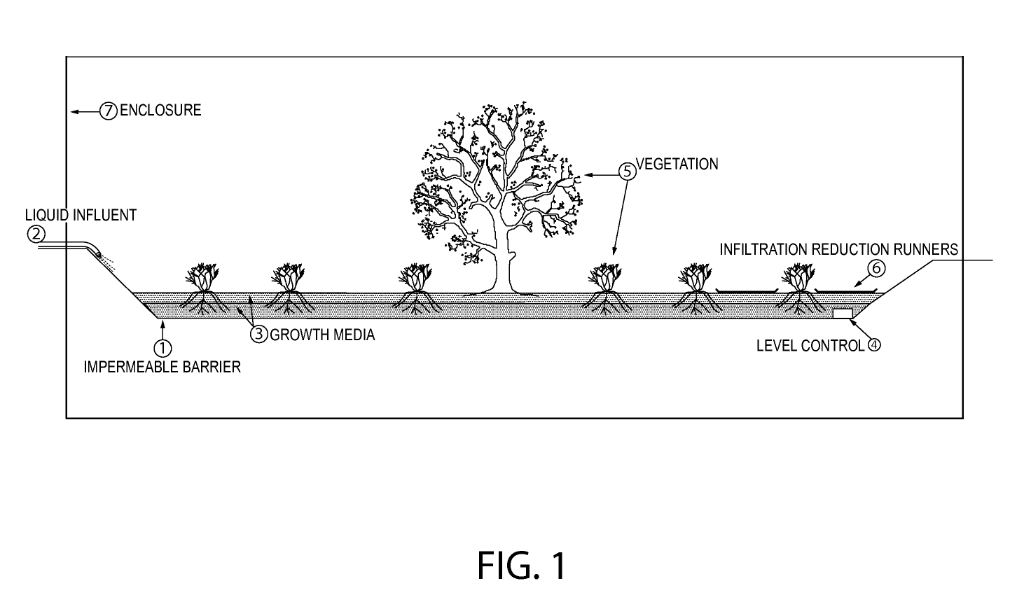

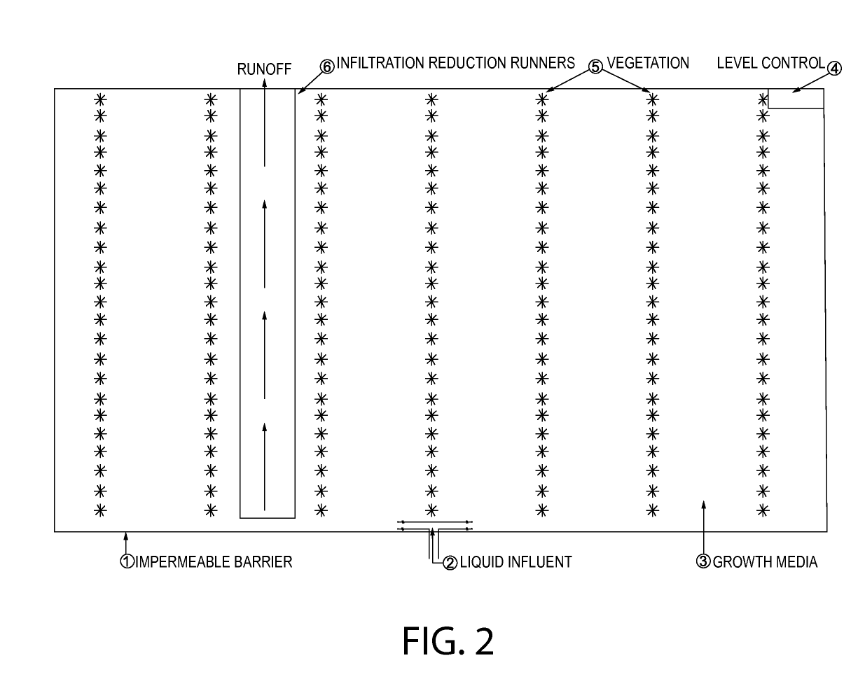

With reference to FIG. 1, a phyto-cell in accordance with an aspect of the invention is shown. The phyto-cell contains an impermeable barrier (1) defining a perimeter and base of the phyto-cell; a liquid influent (2) connected to the phyto-cell for distributing influent into the phyto-cell; a growth media (3) located in the area defined by the impermeable barrier; (4) a level control for controlling the amount of influent in the phyto-cell and/or recirculation of influent within the cell, and vegetation (5) in the growth media for consuming the influent. The phyto-cell disclosed in FIG. 1 may contain infiltration reduction runners (6). The phyto-cell may contain an enclosure (7) (e.g., a greenhouse type structure) so that it becomes a fully contained phyto-cell. FIG. 2 shows a top view of a phyto-cell in accordance with an aspect of an illustrative embodiment.

In a preferred embodiment, the impermeable barrier is either a manufactured or natural material that will contain and prevent the loss of soil or moisture or any other material from leaving the phyto-cell through the impermeable barrier. A preferred material is HDPE geosynthetic liner. The phyto-cell may include a secondary containment barrier if desired. Without enclosure 7, the phyto-cell is a “Contained Phyto Cell.” With enclosure 7, the phyto-cell is a “Fully-Contained Phyto Cell.” When used for an application in the Solid Waste Industry, the phyto cell may be located either outside of, or within, the footprint of a landfill.

In a preferred embodiment, the phyto-cell as described herein may be located above ground level, partially above ground level, or even below ground level. When located above ground level, the phyto-cell contains sufficient supports so as to maintain its structure (e.g., soil berm, steel posts/pillars or other structures connected around the frame of the phyto-cell).

With regard to the liquid influent, this is the point or points at which liquid enters the phyto-cell. The liquid may be distributed by various means including, but not limited to, open or perforated pipe(s) into the cell at one or more distribution points, sprinklers, drip irrigation, or other methods and could be distributed either above, at, or below the growth media surface. The liquid could be any type of wastewater which is desired to be transpired by the system. This would include any type of wastewater or waste liquids including, but not be limited to, industrial wastewater, agricultural wastewater, domestic sewage wastewater, leachate, mining liquids, liquid hazardous or non-hazardous waste, or other liquids or chemicals.

With regard to the growth media, in a preferred embodiment the media includes any types of soil or other media that is capable of supporting plant life including but not limited to sand, silt, clay soils, crushed glass, mulch, biosolids, and any other media that is capable of supporting plant growth including water or the wastewater itself for hydroponic applications. A layer or layers of additional materials of higher permeability (e.g., crushed rocks, sand, crushed glass or other material) may be placed between the growth media and the impermeable barrier so as to facilitate flow of the wastewater in the phyto-cell.

With regard to the level control, it is highly preferred that the liquid level in the phyto cell can be controlled. The method of control will depend on specific project needs and may include, but not be limited to, natural overflow into a collection system, French drain, or mechanical level control with pumps, pipes and/or valves. Liquids removed may be pumped to a storage structure and recirculated back through the phyto-cell or sent to another phyto-cell for consumption.

With regard to the vegetation contained in the phyto-cell, plants such as grasses, trees or other vegetation that are suitable to treat/transpire liquid influent may be used. In a preferred embodiment, the vegetation is vetiver grass.

The size of the phyto-cell is determined on a site by site basis factoring in such considerations as land available and the amount of influent that needs to be consumed. A person of skill in the art may determine the amount of moisture than can be transpired by the plants used in the growing climate where the phyto-cell is located.

A typical cell can process (consume) between 250,000 gallons to 1,000,000 gallons per acre per year of influent. In a preferred embodiment, the cell can process over 1,500,000 gallons per acre per year of influent. The density of plantings in the cell depends on the transpiration capacities of the plant chosen and the local climate where the cell is installed. In a preferred embodiment, the cell would exceed half an acre in size.

The phyto-cell containment barrier may be made of a variety of materials using natural or synthetic low permeable or impermeable materials. For example, clay, bentonite clay, plastic, geosynthetic liners, concrete, steel, or other materials with the desired low permeable to impermeable properties may be used. A person of ordinary skill in the art would recognize that by saying that the phyto-cell has an impermeable barrier, it does not mean that the barrier is truly “impermeable”. Rather, it means that the barrier either lets no wastewater penetrate or only allows wastewater to penetrate to an extent such that the wastewater does not pose a significant threat to the surrounding soil and/or groundwater.

In a further preferred embodiment, the infiltration reduction runners comprise any physical means of reducing precipitation from entering the phyto cell including but not limited to sheet plastic, manufactured geosynthetic membrane/materials, an open-air structure with roof, or other structure. The runners may be anchored or built with a ballast or other weighting to keep in place if necessary for specific project requirements. Precipitation may be routed out of the contained phyto-cell.

The infiltration reduction runners can act as tracks for machinery to move about the phyto-cell. Alternatively, separate tracks may be used in addition to the runners. The phyto-cell may be designed so that machinery runs directly on the growth media.

Machinery may be used in the phyto-cell for routine plant maintenance and/or replacement. For example, when vetiver grass is used as the vegetation, it may need to be mowed between one to three times per year. The use of tracks in the phtyo-cell permits transporting the mower around the phyto-cell.

With regard to the enclosure, the enclosure may be any means of fully enclosing the phyto cell in order to better control the environment in which the plants grow. This includes, but is not limited to a greenhouse or other enclosure, including the use of HVAC systems. The enclosure would allow for a year-round controlled environment to grow the plants and operate the invention. A fully enclosed phyto-cell is highly advantageous when vetiver is used as the plant material in the cell. Vetiver is currently limited by climate and will not survive in colder climates. If enclosed, this plant could be used on a year round basis in any climate as the vegetation. Other vegetation may undergo a dormant (non-growing) season in cold weather. Use of a fully enclosed phyto-cell permits year-round growth. Artificial light may also be used to enhance the growth of plants and transpiration of liquids. A subsurface ground heating system could also be installed to extend the growing season of the vegetation.

In locations using a fully enclosed phyto-cell, the building may be heated using traditional heaters or alternate heat sources such as solar, geothermal, or excess heat from other nearby industrial activities. For example, at a facility that has a flare, it is possible to use the waste heat from the flare to heat the building, making the process even more environmentally friendly. Waste heat from any industrial plant could be used, or any means of controlling the environment to desired conditions, including any other HVAC sources.

A further benefit of the fully contained phyto cell is that it keeps precipitation out of the system. This is also a great benefit and greatly increases the capacity of the phyto-utilization system to process more wastewater per unit area.

The phyto-cells described herein may be used to treat contaminated soils. In that case, the contained cell is still protective of surrounding soil and groundwater, but much of the apparatus described above (e.g. irrigation methods and equipment, etc.) would be unnecessary. The process for soil treatment includes placing contaminated soils or other media into the phyto cell and allowing the phytoremediation process to remediate contaminants, followed by removal of remediated soils for disposal or re-use.

It would be understood that additional processes could be added to enhance remediation such as heat (waste heat from a flare or other process, or heat from fuel) as described above. In addition, additives to enhance breakdown of contaminants (oxidizers or other known in-situ or ex-situ enhanced remediation additives) may be used. The system may be aerated. In addition, biological inoculants to enhance breakdown of contaminants, UV, ozone, surfactants, etc, may be used.

Solar panels may be used to generate electricity/heat, and a solar panel could be built so that the extra heat generated that is not converted to electricity could be used to evaporate more liquid to increase the amount of liquid processed per unit area. Circulated air or other methods could be used to help evaporate more liquid to reduce volume.

Air from a fully enclosed phyto cell may be treated if there were reason (odor, VOCs, etc.) to perform such treatment.

Another benefit of the phyto-cells described herein is that the biomass produced could be used as a renewable biofuel or in the production of cellulosic ethanol, or for other productive uses. For example, it is highly preferred to use vetiver grass as biomass since it has a high production rate and because there are beneficial uses of the material.

It has been surprisingly found that the embodiments described herein result in significant cost savings over hauling away wastewater. Typically, the total cost for transportation by tanker truck and disposal by a municipal wastewater treatment plant (WWTP) ranges from $0.02 to $0.15 or even up to $0.50/gallon. Some WWTPs will accept leachate because it is a source of revenue. However, some WWTPs will not accept leachate because it can upset the delicate balance of microbes needed in the WWTP. In addition, some WWTPs refuse to accept leachate because of fear that leachate will cause them to be unable to meet EPA effluent quality limits. Some WWTPs simply do not have the capacity to take the volume.

A newer trend in wastewater treatment includes UV disinfection. However, many WWTPs utilizing this approach are refusing to accept leachate or other wastewater because it interferes with the effectiveness of the UV disinfection. From some WWTP's perspective, not accepting leachate also reduces loading to a WWTP. In addition, with a phyto-cell, no additional contaminants are discharged into any body of water.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A phyto-cell comprising an impermeable barrier defining a perimeter and base of the phyto-cell; a liquid influent connected to the phyto-cell for distributing influent into the phyto-cell; a growth media located in the area defined by the impermeable barrier; and vegetation in the growth media for consuming the influent.

2. The phyto-cell of claim 1, wherein the base defined by the impermeable barrier is between 1 to 10 feet beneath the surface of the growth media.

3. The phyto-cell of claim 2, wherein the impermeable barrier is between 2 to 5 feet beneath the surface of the growth media.

4. The phyto-cell of claim 1, wherein the vegetation is a hybrid poplar tree, a willow tree, vetiver grass, or a combination thereof.

5. The phyto-cell of claim 1, wherein the phyto-cell further comprises a level control for controlling the amount of influent in the cell.

6. The phyto-cell of claim 1, wherein the phyto-cell further comprises an infiltration reduction runner.

7. The phyto-cell of claim 1, wherein the phyto-cell further comprises a layer of material between the growth media and the base defined by the impermeable barrier.

8. A fully contained phyto-cell comprising an impermeable barrier defining a perimeter and base of the phyto-cell; a liquid influent connected to the phyto-cell for distributing influent into the phyto-cell; a growth media located in the area defined by the impermeable barrier; vegetation in the growth media for consuming the influent; and an enclosure over the surface of the phyto-cell.

9. The phyto-cell of claim 8, wherein the base defined by the impermeable barrier is between 1 to 10 feet beneath the surface of the growth media.

10. The phyto-cell of claim 9, wherein the impermeable barrier is between 2 to 5 feet beneath the surface of the growth media.

11. The phyto-cell of claim 8, wherein the vegetation is a hybrid poplar tree, a willow tree, vetiver grass, or a combination thereof.

12. The phyto-cell of claim 8, wherein the phyto-cell further comprises a level control for controlling the amount of influent in the cell.

13. The phyto-cell of claim 8, wherein the phyto-cell further comprises an infiltration reduction runner.

14. The phyto-cell of claim 8, wherein the phyto-cell further comprises a layer of material between the growth media and the base defined by the impermeable barrier.

15. The fully contained phyto-cell of claim 8, wherein the enclosure is a greenhouse.

16. The fully contained phyto-cell of claim 15, wherein the vegetation in the growth medium comprises vetiver grass.

17. A method of consuming influent comprising delivering influent to a phyto-cell, wherein the phyto-cell comprises:
an impermeable barrier defining a perimeter and base of the phyto-cell;
a liquid influent connected to the phyto-cell for distributing influent into the phyto-cell;
a growth media located in the area defined by the impermeable barrier;
and vegetation in the growth media for consuming the influent; and
contacting the influent with the vegetation in the phytocell so that the wastewater is consumed by the phytocell.

18. The method of claim 17, wherein the phyto-cell is fully enclosed.

19. The method of claim 17, wherein the influent is wastewater.

20. The method of claim 17, wherein the influent is leachate.
